(19) United States
(12) Patent Application Publication
(10) Pub. No.: US 2022/0312736 A1
(43) Pub. Date: Oct. 6, 2022

(54) Animal Treat Disbursement Toy

(71) Applicant: Cameron Leff, Lutz, FL (US)

(72) Inventor: Cameron Leff, Lutz, FL (US)

(21) Appl. No.: 17/219,443

(22) Filed: Mar. 31, 2021

(51) Int. Cl. A01K 15/02

(52) U.S. Cl. CPC A01K 15/026

(57) ABSTRACT

The disclosure is the only product of its kind that takes the concept of a generic pet toy and modifies it to meet the mental demand and playful engagement of common domestic animals. The disclosure is uniquely designed to foster and safeguard stimulation to curb destructive behaviors and enhance the problem-solving skills of the varying dog and/or cat breeds. It includes a dog bone chew toy having a point of attachment and configured to define a plurality of treat dispersement locations. It also has a base including a top attachment complementary to the dog bone Chew toy point of attachment, the base having a bottom attachment for a flat surface. The disclosure further has a pedestal between the top attachment of the base. the pedestal configured to set off the top attachment from the base.

### BACKGROUND

Many individuals enjoy sharing a home with a loveable animal companion, a cat or dog, as they often become a member of the family and instinctively strive to captivate the attention of their human caregiver. However, many pet owners do not have the time to continuously play and reward their furry friends with treats throughout the day. There have been no products available as original equipment or as an aftermarket to address this problem.

An apparatus or device to provide mental stimulation helping to provide entertainment to alleviate the animal's boredom. Thus allowing the human caregiver to free up time and receive respite from needing to continuously play with their animal.

There have been no products available as original equipment or as an aftermarket to address this problem either.

There exists a need for a device such above that is not being met by any known or disclosed device or system of present.

### SUMMARY OF THE INVENTION

The main purpose of the disclosure is to provide enriched entertainment and treats to household animals. The present invention overcomes the above referred to difficulties in a convenient, simple and efficient manner. This invention provides mental stimulation helping to provide entertainment to alleviate the animal's boredom. Thus allowing the human caregiver to free up time and receive respite from needing to continuously play with their animal.

The disclosure includes a dog bone chew toy having a point of attachment and configured to define a plurality of treat dispersement locations. it also has a base including a top attachment complementary to the dog bone chew toy point of attachment, the base having a bottom attachment for a flat surface. The disclosure further has a pedestal between the top attachment of the base, the pedestal configured to set off the top attachment from the base.

### BRIEF DESCRIPTION OF THE DRAWINGS

FIG. 1 is a front perspective view of the Animal Treat Disbursement Toy apparatus in accordance with an embodiment of the present disclosure.

FIG. 2 is a front perspective view of the Animal Treat Disbursement Toy apparatus in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

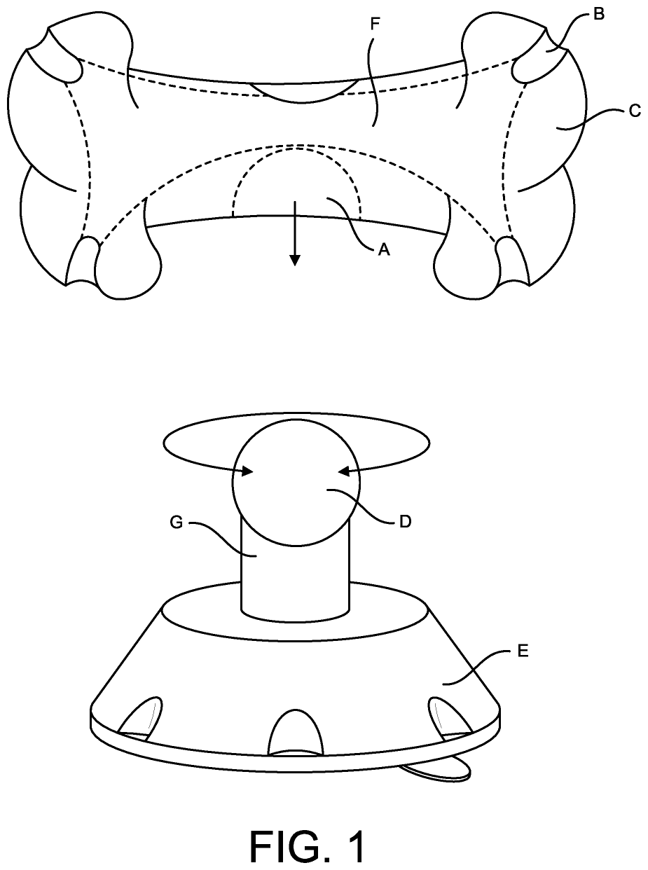

FIG. 1 is a front perspective view of the Animal Treat Disbursement Toy showing: Click-on cavity referenced as A., Cavities/holes for dog treats referenced as B., Bone shape or any shape made of tough safe plastic referenced as C., Pivot/top attachment to attach bone referenced as D., Secure twist suction base referenced as E., Cavity to hold treat and dispense to all holes referenced as F., in accordance with an embodiment of the present disclosure. The perspective also includes the pedestal G between the base E and the top attachment D.

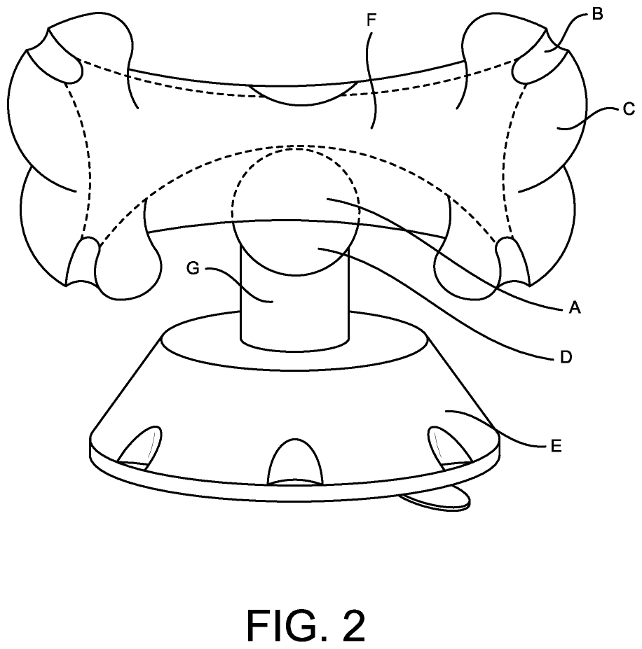

FIG. 2 is a front perspective view of the Animal Treat Disbursement Toy showing: Click-on cavity referenced as A., Cavities/holes for dog treats referenced as B., Bone shape or any shape made of tough safe plastic referenced as C., Pivot/top attachment to attach bone referenced as D., Secure twist suction base referenced as E., Cavity to hold treat and dispense to all holes referenced as F., in accordance with an embodiment of the present disclosure. The perspective also includes a pedestal, boss or standoff between the top pivot swivel attachment D and the base E.

The present disclosed Animal Treat Disbursement Toy, also known as “The Brain Train”, introduces an interchangeable product designed to provide pets with enhanced stimulation and prevent boredom. The Brain train features an innovative bone-shaped apparatus secured to a base crafted to attach to various solid surfaces. The detachable bone-shaped apparatus is derived from durable hard plastic capable of enduring bites from the jaw of even the strongest of domestic animals and is comprised of four cavities on each end and a large cavity in the center accustomed to safeguard several types of kibble or animal spreads. The product provides the animal with mental stimulation by spinning the bone as the animal attempts to retrieve the treat. The bone-shaped apparatus is connected to a suction base via a pivoting fixture meant to attach to the lower center cavity of the bone. The base of the Brain Train can be secured and locked into position via a simple twisting mechanism, preventing displacement and allowing for continuous functionality. The disclosure can be easily assembled and is offered in recyclable packaging. The Brain Train disclosure is a versatile and novel mechanism for dispensing treats and satisfying the boredom of pets.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A dog toy comprising:
a dog bone chew toy comprising a point of attachment and configured to define a plurality of treat dispersement portions; and
a base comprising a top attachment complementary to the dog bone chew toy point of attachment, the base having a bottom attachment to a surface.

2. The dog toy of claim 1, wherein the dog bone chew toy is shaped like a dog biscuit with a central shaft and one lobe on either end of the central shaft.

3. The dog toy of claim 1, wherein the point of attachment is a click-on cavity.

4. The dog toy of claim 1, wherein the plurality of treat dispersement portions are cavities for dog treats.

5. The dog toy of claim 1, wherein the top attachment is a pivot top configured to pivot and to swivel via a pedestal between the top attachment and the base.

6. The dog toy of claim 1, further comprising a pedestal between the dog bone chew toy and the top attachment of the base.

7. The dog toy of claim 1, wherein the bottom attachment of the base is a suction base

8. The dog toy of claim 1, wherein the plurality of treat dispersement portions are disposed in a lobe on either side of a central shaft of the dog bone chew toy.

9. The dog toy of claim 1, wherein the plurality of treat dispersement portions are disposed in a central shaft of the dog bone chew toy.

10. The dog toy of claim 1, wherein the treat dispersement portions are disposed in a central shaft of the dog bone chew toy and in a lobe on either side of the central shaft.

11. The dog toy of claim 1, further comprising a hollow central shaft configured to disperse a dog treat to the plurality of treat dispersement portions.

12. The dog toy of claim 1, wherein the plurality of treat dispersement portions extend from an exterior of the dog bone chew toy into an interior thereof and are in fluidic communication with each other.

13. The dog toy of claim 1, wherein the a core of the dog bone chew toy is hollow and extends to the plurality of treat dispersement portions.

14. The dog toy of claim 1, wherein the dog bone chew toy comprises a durable plastic composite configured to have similar characteristics with natural dog bone.

15. A dog toy device comprising:
a dog bone chew toy comprising a point of attachment and configured to define a plurality of treat dispersement portions;
a base comprising a top attachment complementary to the dog bone chew toy point of attachment, the base having a bottom attachment to a flat surface; and
a pedestal between the top attachment of the base, the pedestal configured to set off the top attachment from the base.

16. The dog toy of claim 15, wherein the plurality of treat dispersement portions are cavities for receiving an edible dog treat.

17. The dog toy of claim 15, wherein the top attachment is a pivot top configured to pivot and to swivel via a pedestal between the top attachment and the base.

18. The dog toy of claim 15, wherein the bottom attachment of the base is a suction base for attachment to a semi-flat surface.

19. The dog toy of claim 15, further comprising a hollow central shaft configured to disperse a dog treat to the plurality of treat dispersement portions.

20. The dog toy of claim 15, wherein the point of attachment is equidistant from a first lobe of the dog bone chew toy to a second lobe thereof.
